(19) United States
(12) Patent Application Publication
(10) Pub. No.: US 2007/0266335 A1
(43) Pub. Date: Nov. 15, 2007

(54) Providing a standard user interface (UI) across disparate display interfaces

(75) Inventors: Tobiasz A. Zielinski, Monroe, WA (US); Jennifer R. Stallard, Redmond, WA (US); William Mak, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/433,499

(22) Filed: May 12, 2006

(51) Int. Cl. G06F 3/048; G06F 3/00

(52) U.S. Cl. 715/787; 715/761

(57) ABSTRACT

A system and method for providing a standard user interface (UI) across disparate display interfaces is disclosed. The technology initially determines a scaling factor for a UI containing a plurality of elements. The technology also establishes a reflow characteristic of the plurality of elements within the UI. The technology additionally provides a scrollbar characteristic for the UI. In so doing, the reflow characteristic is utilized when the scaling factor results in a UI that does not fit on a display interface. Moreover, the scrollbar characteristic is utilized when the reflow characteristic also results in a UI that does not fit on a display interface.

### BACKGROUND

Presently, computers are utilized in almost all aspects of daily lives. For example, a typical person may use a desktop or mobile computer for work, entertainment or the like. Moreover, a user may interact with a plurality of computers and view a plurality of different displays throughout their day, week, or year.

For example, a user may traditionally work with a fixed display screen that is fairly large. The larger display allows more information to be displayed or allows the information to be displayed in a larger manner. However, when the user travels, they may utilize a mobile computer with a smaller display to continue working or playing while traveling. In general, the smaller laptop type computing device is preferential to a personal digital assistant (PDA), palmtop, mobile phone or the like, due to the processing power, operating system and application availability found in the laptop computer.

Normally, the laptop display is significantly smaller than the fixed display screen used in the home or office. For example, a 17 inch screen is fairly small in the context of a desk, office, or room monitor. However, a 17 inch screen is very large in the context of a laptop display. In fact, as space is restricted the smaller screen is becoming the option of choice.

For example, when traveling on an aircraft, the laptop with a large screen may be significantly impacted due to the amount of room available, the tilting of seats, and the like. While a laptop or notebook with a smaller screen will remain accessible and usable. Due to the recognized advantage of the smaller screen, a significant amount of focus has been directed toward making smaller laptop or notebook type devices that are as capable as a standard computer and contain significantly advanced displays to provide a crisp clear image for a user. One example of the smaller laptops is the ultra mobile personal computer (UMPC). These devices normally have a display size in the range of approximately 6-10 inches.

The display size is important and is therefore limited in size reduction. For example, the limitations of the screen size is based on the ability for the display to allow the user to interact with the applications on the screen. In general, it is the focus of the laptop device to display any applications in a manner similar to the usual day to day operation of a full size computer such as a desktop or larger screened laptop.

One method for providing similarity between displays is to reduce the size of objects on a small display. For example, an object that is 3 inches by 3 inches on a large display may be reduced to 1 inch by 1 inch on a smaller display. However, while this method provides a similar display appearance, it significantly impacts user interaction. For example, a user may not be able to see, read, interact with, select, or clearly identify objects that have received such a dramatic reduction.

A second solution is to re-write the application for the smaller display size. In so doing, the user would be able to see, interact, select, and clearly identify objects. However, this method results in a user having to relearn an application. For example, the user may have to search for tools, and the like that have been moved, removed, hidden, or otherwise changed.

Therefore, what is needed is a method for providing a standard user interface (UI) across disparate display interfaces.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and method for providing a standard user interface (UI) across disparate display interfaces is disclosed. The technology initially determines a scaling factor for a UI containing a plurality of elements. The technology also establishes a reflow characteristic of the plurality of elements within the UI. The technology additionally provides a scrollbar characteristic for the UI. In so doing, the reflow characteristic is utilized when the scaling factor results in a UI that does not fit on a display interface. Moreover, the scrollbar characteristic is utilized when the reflow characteristic also results in a UI that does not fit on a display interface.

### DESCRIPTION OF THE DRAWINGS

The accompanying drawings, which are incorporated in and form a part of this specification, illustrate embodiments of the technology for providing a standard user interface (UI) across disparate display interfaces and, together with the description, serve to explain principles discussed below:

FIG. 1 is a diagram of an exemplary computer system used in accordance with embodiments of the present technology for providing a standard user interface (UI) across disparate display interfaces.

FIG. 2 is a block diagram of an exemplary user interface standardizer in accordance with an embodiment of the present technology for providing a standard user interface (UI) across disparate display interfaces.

FIG. 3 is an exemplary block diagram of a UI in accordance with an embodiment of the present technology for providing a standard user interface (UI) across disparate display interfaces.

FIG. 4 is an exemplary block diagram of a reflow of a UI in accordance with another embodiment of the present technology for providing a standard user interface (UI) across disparate display interfaces.

FIG. 5 is an exemplary block diagram of a scrollbar version of a reflow of a UI in accordance with another embodiment of the present technology for providing a standard user interface (UI) across disparate display interfaces.

FIG. 6 is a flowchart of operations performed in accordance with one embodiment of the present technology for providing a standard user interface (UI) across disparate display interfaces.

The drawings referred to in this description should be understood as not being drawn to scale except if specifically noted.

### DETAILED DESCRIPTION

Reference will now be made in detail to embodiments of the present technology for providing a standard user interface (UI) across disparate display interfaces, examples of which are illustrated in the accompanying drawings. While the technology for providing a standard user interface (UI) across disparate display interfaces will be described in conjunction with various embodiments, it will be understood that they are not intended to limit the present technology for providing a standard user interface (UI) across disparate display interfaces to these embodiments. On the contrary, the presented technology for providing a standard user interface (UI) across disparate display interfaces is intended to cover alternatives, modifications and equivalents, which may be included within the spirit and scope the various embodiments as defined by the appended claims.

Furthermore, in the following detailed description, numerous specific details are set forth in order to provide a thorough understanding of the present technology for providing a standard user interface (UI) across disparate display interfaces. However, the present technology for providing a standard user interface (UI) across disparate display interfaces may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “performing”, “generating”, “displaying”, “selecting”, “scrolling”, “highlighting”, “presenting”, “testing”, “identifying”, “reporting”, “prompting”, “suppressing”, “providing”, and “refreshing” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for providing a standard user interface (UI) across disparate display interfaces is also well suited to the use of other computer systems such as, for example, optical and mechanical computers. Additionally, it should be understood that in embodiments of the present technology for providing a standard user interface (UI) across disparate display interfaces, one or more of the steps can be performed manually.

### Example Computer System Environment

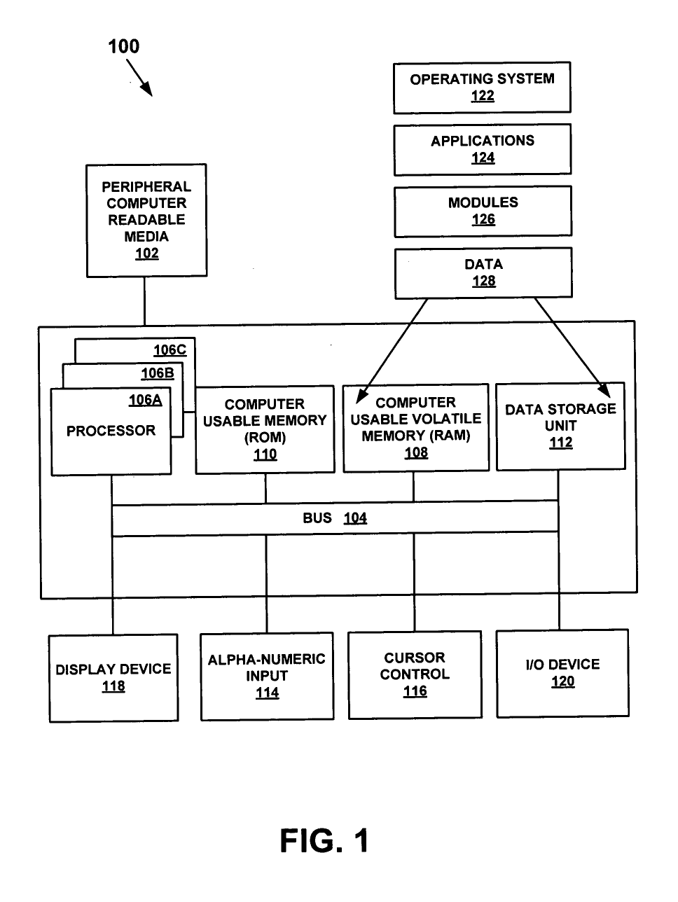

With reference now to FIG. 1, portions of the technology for providing a standard user interface (UI) across disparate display interfaces are composed of computer-readable and computer-executable instructions that reside, for example, in computer-usable media of a computer system. That is, FIG. 1 illustrates one example of a type of computer that can be used to implement embodiments, which are discussed below, of the present technology for providing a standard user interface (UI) across disparate display interfaces.

FIG. 1 illustrates an exemplary computer system 100 used in accordance with embodiments of the present technology for providing a standard user interface (UI) across disparate display interfaces. It is appreciated that system 100 of FIG. 1 is exemplary only and that the present technology for providing a standard user interface (UI) across disparate display interfaces can operate on or within a number of different computer systems including general purpose networked computer systems, embedded computer systems, routers, switches, server devices, consumer devices, various intermediate devices/artifacts, stand alone computer systems, and the like. As shown in FIG. 1, computer system 100 of FIG. 1 is well adapted to having peripheral computer readable media 102 such as, for example, a floppy disk, a compact disc, and the like coupled thereto.

System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C.

System 100 also includes computer usable non-volatile memory 110, e.g. read only memory (ROM), coupled to bus 104 for storing static information and instructions for processors 106A, 106B, and 106C. Also present in system 100 is a data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick or special keys on alpha-numeric input device 114 capable of signaling movement of a given direction or manner of displacement. Alternatively, it will be appreciated that a cursor can be directed and/or activated via input from alpha-numeric input device 114 using special keys and key sequence commands.

System 100 is also well suited to having a cursor directed by other means such as, for example, voice commands. System 100 also includes an I/O device 120 for coupling system 100 with external entities. For example, in one embodiment, I/O device 120 is a modem for enabling wired or wireless communications between system 100 and an external network such as, but not limited to, the Internet. A more detailed discussion of the present technology for providing a standard user interface (UI) across disparate display interfaces is found below.

Referring still to FIG. 1, various other components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment, the present technology for providing a standard user interface (UI) across disparate display interfaces, for example, is stored as an application 124 or module 126 in memory locations within RAM 108 and memory areas within data storage unit 112.

### Overview

As an overview, in one embodiment, the present technology provides a method and system for providing a standard user interface (UI) across disparate display interfaces. That is, instead of modifying a UI by significantly shrinking the UI elements based on screen size, resolution, and the like, the present technology takes advantage of screen resolution and pixel density to ensure that the size of individual UI elements will not fall below a usable physical minimum. In so doing, screen characteristics aside, the UI is the same physical size on all displays.

In one embodiment, the present technology utilizes a scaling factor to maintain constant physical size of the UI element. For example, on a 10 inch display and a 14 inch display with the same resolution 1024×768, the density of the pixels will vary. Thus, without a scaling factor, when the UI elements are displayed on both screens, the UI elements on the 14 inch screen will be physically larger than the UI elements on the 10 inch screen. The scaling factor accounts for the variance in the density of the pixels as well as the variance in the screen size resulting in UI elements on both displays having the same physical size. The same methodology applies to same size displays with different resolution, different size displays with different resolution, and the like.

Furthermore, in one embodiment, the UI elements all grow (in both dimensions) to accommodate large fonts, but do not shrink below the preset minimum. Instead, if further space is needed after the UI elements are shrunk to their preset minimum, the UI elements are reflowed. That is, a layout of a different aspect ratio (e.g., portrait instead of landscape), UI element configuration, or the like is utilized. Finally, as a last resort, scrollbars are provided to allow a user to navigate an extremely small or low dot per inch (dpi) screen. The present technology also scales all UI elements up (in both dimensions) to accommodate large fonts as cleanly as possible.

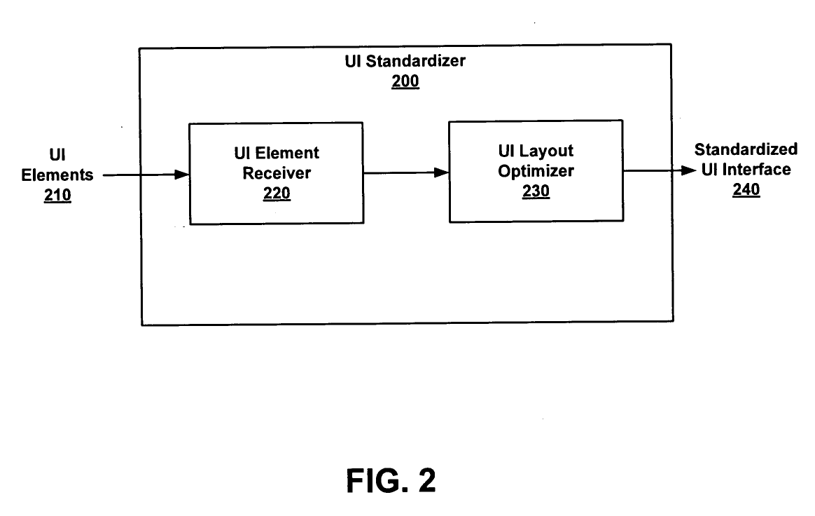

With reference now to FIG. 2, a block diagram of an exemplary UI standardizer is shown in accordance with an embodiment of the present technology for providing a standard user interface (UI) across disparate display interfaces. In one embodiment, UI standardizer 200 includes a UI element receiver 220 coupled with a UI layout optimizer 230.

In one embodiment, UI element receiver 220 is utilized to receive UI elements 210. While UI layout optimizer 230 creates a standardized UI layout 240 of the plurality of UI elements. Moreover, the UI layout optimizer 230 provides a scaling factor and a reflow protocol for the standardized UI layout 240 such that each of the plurality of the UI elements in the standardized UI layout 240 maintains a minimum standard physical size regardless of a display interface on which it is presented.

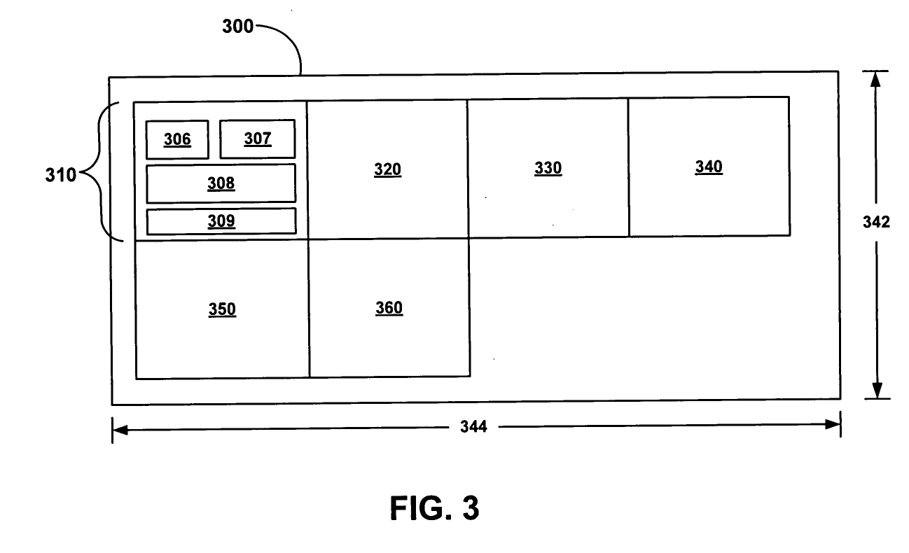

Referring now to FIG. 3, a block diagram of an exemplary UI 300 is shown in accordance with an embodiment of the present technology for providing a standard user interface across disparate display interfaces. In general, UI 300 includes a plurality of UI elements, e.g., 310-360. Moreover, UI 300 includes the tile elements 306-309 within one UI element 310. Although, the tile elements 306-309 are shown only in one UI element 310, each UI element may have tile elements therein.

In general, a tile element provides a property, value, name, adjustment, setting or the like for a portion of the UI element. For example, as described herein, the tile element can include an Icon, a title, a control, a status, or any other property of the element a user or technician wants to show or present. The tile elements can be operational, informational or operational and informational.

In one embodiment, each UI element, e.g., 310-360, will have the same tile elements 306-309. In yet another embodiment, the UI elements may have different numbers of tile elements therein. In one exemplary embodiment, the tile elements include an icon 306, a status 307, a control 308 and a tile name 309. Although the tile elements of UI element 310 are provided herein, they are exemplary. That is, the UI elements are well suited to varying numbers of tile elements including and excluding any or all of the tile elements described herein. Thus, the tile elements of UI element 310 provided herein are exemplary and are described merely for purposes of brevity and clarity.

UI 300 also includes a length measurement 344 and a width measurement 342 of said UI 300. In one embodiment, the length 344 and width 342 are the minimum physical measurements based on the scaling factor.

In one embodiment, UI 300 is the optimal layout for the UI. That is, the UI layout shown in FIG. 3 is the preferential display format including size and shape of the UI. Thus, on any display that has a large enough size to support the minimum dimensions, e.g. 342 and 344, the UI 300 will be displayed in this manner.

Although the UI 300 layout shown in FIG. 3 is described as the optimal layout, it is not the physical layout of FIG. 3 that is optimal. The layout of FIG. 3 is exemplary and subject to change based on design, number of UI elements, number of tiles in each UI element, and the like. Instead, the optimal UI 300 refers to the fact that the UI 300, whatever the actual layout, will remain at least at the same physical size independent of the display. This will remain the case unless and until a display cannot support the minimum dimensions provided.

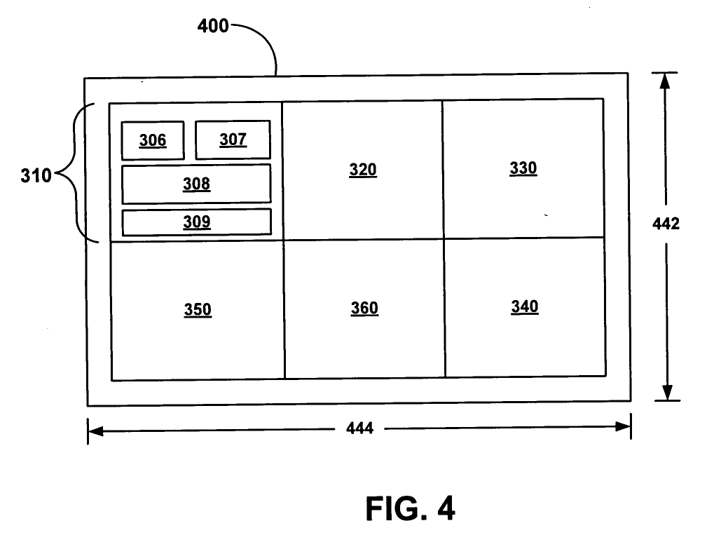

With reference now to FIG. 4, a block diagram of an exemplary reflow of a UI 400 is shown in accordance with another embodiment of the present technology for providing a standard user interface across disparate display interfaces. In general, UI 400 includes the same number of elements, e.g., 310-360, and the same tile elements 306-309, as FIG. 3. Therefore, for purposes of brevity and clarity, the elements will not be described again.

However, unlike UI 300, UI 400 has different length 444 and width 442 characteristics. Because of the different characteristics, the optimal UI 300 layout as shown in FIG. 3 could not be utilized. Therefore, the UI element 340 was reflowed to fit within the UI 400 footprint without reducing the size of the UI elements, e.g., 310-360, below their minimum standard physical size.

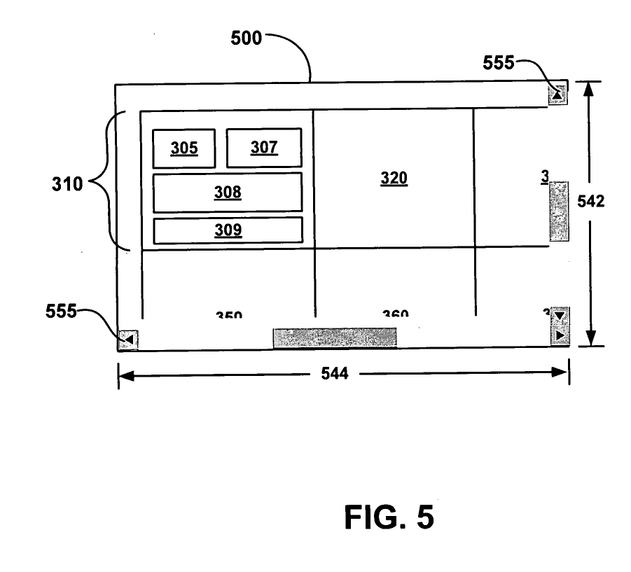

Referring now to FIG. 5, a block diagram of an exemplary scrollbar version of a reflow of a UI 500 is shown in accordance with another embodiment of the present technology for providing a standard user interface across disparate display interfaces. UI 500 includes the same number of elements, e.g., 310-360, and the same tile elements 306-309, as FIGS. 3 and 4. Therefore, for purposes of brevity and clarity, the elements will not be described again.

However, UI 500 had different length 544 and width 542 characteristics than either UI 300 or IU 400. Because of the different characteristics, the optimal UI 300 layout as shown in FIG. 3 could not be utilized. Moreover, the reflowed layout of FIG. 4 did not resolve the display size issue. Therefore, scrollbars 555 were added to provide the user access to the entire UI 500. In so doing, the UI element 340 remains reflowed as shown in FIG. 4 and the size of the UI elements, e.g., 310-360, are not reduced below their minimum standard physical size. In one embodiment, the individual tile elements are rendered appropriately based on the pixel density of the display. This individual tile element rendering allows the UI to be the same physical size regardless of pixel density.

### Operation

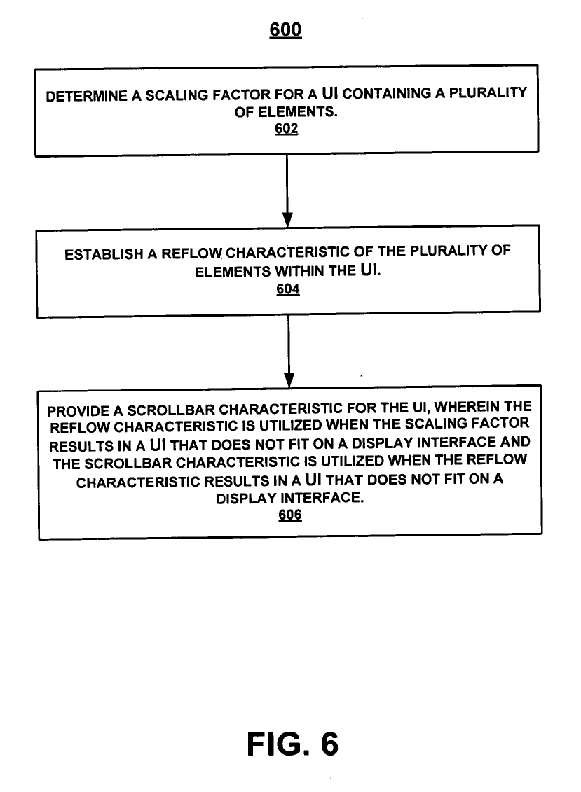

With reference now to FIG. 6, a flowchart 600 of operations performed in accordance with one embodiment of the present technology for providing a standard user interface (UI) across disparate display interfaces is shown. Advantageously, the present technology provides a method of displaying a UI with a standard minimum size. Moreover, unlike present approaches, the same standard minimum physical size of the elements within the UI is maintained regardless of the display on which the UI is presented.

Referring now to 602 of FIG. 6 and to FIG. 3, one embodiment of the present technology determines a scaling factor for a UI containing a plurality of elements. In one embodiment, the scaling factor is determined for a UI 300 containing a plurality of elements 310-360, wherein the elements contain a plurality of tiles 306-309. In one embodiment, the most constrained tile of the plurality of tiles is used as a limiting factor in the calculating.

The term scaling factor refers to maintaining constant physical size of the UI element. For example, on a 10 inch display and a 14 inch display with the same resolution 1024×768, without a scaling factor, when the UI elements are displayed on both screens, the UI elements on the 14 inch screen will be physically larger than the UI elements on the 10 inch screen. The scaling factor accounts for the variance in the density of the pixels as well as the variance in the screen size resulting in UI elements on both displays having the same physical size. The same methodology applies to same size displays with different resolution, different size displays with different resolution, and the like.

As part of the determining of the scaling factor, the limiting factors of the UI element number and UI element tile layout are determined. In other words, the limiting factors are element sizes (e.g., 310-360 of FIG. 3) and tile sizes (e.g., 306-309 of FIG. 3). In general, the limiting factor is the UI element, or UI element tile dimension that is the most constrained. In some cases, it is also possible for more than one dimension to be the most constrained because different conditions can have a different most constrained dimension. In one embodiment, all the most constrained dimensions are considered.

For example, one embodiment utilizes the UI layout optimizer 230 of FIG. 2 to generate a reference layout prior to determining the scaling factor. That is, a reference layout is created for each of the elements of the UI, wherein the reference layout optimizes a location for each of the elements of the UI. Moreover, the reference layout is used to determine a minimum size for each of the elements in the UI.

In one embodiment, the layout is optimized for the scenarios that will occur most often. In other words, things like supported resolutions, dpi, and font size become factors in the reference layout. For example, the layout pictured in UI 300 was chosen to fit on the supported resolutions of 800×600 and above under the most common scenario of 9 pt font on 96 dots per inch (dpi). This UI size was also decided to be used as the minimum size so the controls would always be big enough to provide easy user interaction.

In one embodiment, the most constrained tile of the plurality of tiles is used as a limiting factor in the calculations performed herein. Determining the dimension that is the most constrained is illustrated by using the tile UI elements 306-309. As described herein, the layout of UI element 310 shows four tile elements that have the following exemplary constraints which are provided herein merely for purposes of brevity and clarity.

Icon 306—icons have multiple sizes including 32×32 and 48×48, the icon with the size that is less than or equal to the size of the icon area is centered in it.

Status 307—contains text aligned to the left and centered vertically, may be 1 to 3 lines.

Control 308—can be stretched as needed, some controls may have 1 line of text, controls normally include items such as an adjustment bar, a button, combos and the like.

Tile Name 309—contains text centered vertically and horizontally, 1 line of text.

For benefit of discussion, the status area 307 height will be the limiting factor. In the present example, the element 310 tile layout has a height and width of the minimum icon 306 area as 36 which gives room to center a 32×32 icon 306. If the UI 300 gets scaled up, there will continue to be room for at least a 32×32 icon if not a larger status area 307. The control 308 is very flexible in its size because it can be stretched to fit the scaled area it is given. In the case where the control 308 has text, it is only one line and its relative height is greater than ⅓ the height of the status area 307 which, in the present example, should support 3 lines of text. The tile name area 309 needs to be at least ⅓ the height of the status area 307 to ensure that is tall enough to display one line of text. This is ensured by choosing a reference height that is at least ⅓ the height of the status area 307.

Since, in the present example, the icon 306, control 308, and tile name 309 areas can all be defined in limitations of the status area 307 height, the status area 307 height is selected as the limiting factor. Therefore, if the status area 307 is tall enough to display 3 lines of text at the given font scaled by the current dpi and all other elements are proportioned accordingly, all UI elements (e.g., 310-360) will fit correctly.

Although, the determination of the reference size of the limiting factor is described herein in conjunction with generating a UI layout. The present technology is well suited to determining the limiting factor and the reference size of the limiting factor from any UI. That is, the present technology can establish the reference size and limiting factors by evaluating an already existent UI. Thus, the present technology is capable of being implemented on already existent UI's without requiring initial UI layout modification, generation, alteration or the like.

Referring still to 602 and to FIG. 3, one embodiment determines at least one characteristic of the display interface for use in the scaling factor calculation. That is, the scaling factor can utilize a density of pixels on the display interface in conjunction with a display resolution. For example, if the status area 307 is the limiting factor. Then, the reference size is calculated based on the status area 307 as described in detail herein.

As described herein, the status area 307, in the example, is suggested to contain 3 lines of text. Thus, the necessary scaling factor calculation will include determining the current font being used and then calculating the height of 3 lines of text in that font at the current dpi (calculated current size of limiting factor). The ratio between the calculated current size height and the reference height becomes the scaling factor used to scale all the UI elements. That is,
Scaling Factor=Calculated Current Size Of Limiting Factor/Reference Size Of Limiting Factor

Once the scaling factor is established, the reference layout for all the UI elements 310-360 is created or adjusted accordingly. In one embodiment, the size and placement of the elements 310-360 need only be scaled by the scaling factor to determine their current size and placement.

With reference now to 604 of FIG. 6 and to FIG. 4, one embodiment of the present technology establishes a reflow characteristic of the plurality of elements within the UI. In other words, the reflow characteristic is utilized when the scaling factor results in a UI 300 of FIG. 3 that does not fit on a display interface. As shown in UI 400, when the scaling factor is at its minimum and the UI still does not fit the display, the reflow characteristic is initiated to maintain the minimum standard physical size of the plurality of elements within the UI.

For example, UI 300 with 4 columns on a tablet with a resolution of 600×800 (e.g., in portrait mode) would not quite fit horizontally. However, reflowing the tiles as shown in UI 400, so that there are only 3 columns, will allow the UI to fit very nicely. Thus, adding the ability to reflow UI elements when necessary allows a display to fit all the UI elements 310-360 on the screen.

Referring now to 606 of FIG. 6 and to FIG. 5, one embodiment of the present technology provides a scrollbar characteristic 555 for the UI 500. In one embodiment, the scrollbar characteristic 555 is utilized when the scaling factor results in a UI 300 that does not fit on a display interface and the reflow characteristic results in a UI 400 that does not fit on a display interface. In one embodiment, the scaling factor, the reflow characteristic and the scrollbar characteristic are used to maintain a minimum standard physical size of the plurality of elements within the UI irrespective of the display interface.

Thus, the scrollbars 555 allow all UI 500 elements to be reached even in scenarios such as, really large font size selection, really low screen resolutions and the like where it is not possible to show all UI elements 310-360 at the same time. The result is that only part of the UI 500 is visible at one time, but all the controls (e.g., tiles 306-309) can be reached and the UI 500 remains useable at the minimum standard physical size. As is shown in FIG. 5, reflow was performed before the scrollbars 555 were added.

Additionally, in one embodiment, the determination of a font size characteristic also utilizes the scaling factor. For example, an adjustment to the font size of any tile in the element will not only adjust the selected tile but will also adjust each of a plurality of tiles 306-309 in each of the plurality of elements 310-360 within the UI (e.g., 300, 400 or 500).

Thus, the present embodiments provide a method and system for providing a standard user interface (UI) across disparate display interfaces. In addition, embodiments described herein provide a method and system for providing a standard user interface (UI) across disparate display interfaces which does not shrink below a minimum physical size regardless of the size of the display on which it is provided. That is, because the UI remains standardized, the user can switch between displays such as home large screen displays and mobile smaller displays without a significant reduction in UI recognition, usability, and relearn time.

For example, as ultra mobile personal computers (UMPCs) become more prevalent, the need for creating “one-size fits many” user interfaces becomes increasingly significant, including during the transition from 4:3 to wider screen aspect ratios (where the portrait/landscape orientation changes present more challenging layout scenarios). The present technology described herein allows the UI to remain standardized from display to display thereby providing user recognition and ease of transition from display to display.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for providing a standard user interface (UI) across disparate display interfaces, said computer-implemented method comprising:
determining a scaling factor for a UI containing a plurality of elements;
establishing a reflow characteristic of said plurality of elements within said UI; and
providing a scrollbar characteristic for said UI, wherein said reflow characteristic is utilized when said scaling factor results in a UI that does not fit on a display interface and said scrollbar characteristic is utilized when said reflow characteristic results in a UI that does not fit on a display interface.

2. The computer-implemented method of claim 1 further comprising:
utilizing screen resolution and pixel density to determine said scaling factor for said UI containing said plurality of elements.

3. The computer-implemented method of claim 1 further comprising:
utilizing said scaling factor and said reflow characteristic to maintain a minimum standard physical size of said plurality of elements within said UI regardless of said display interface.

4. The computer-implemented method of claim 1 further comprising:
utilizing said scaling factor, said reflow characteristic and said scrollbar characteristic to maintain a minimum standard physical size of said plurality of elements within said UI irrespective of said display interface.

5. The computer-implemented method of claim 1 wherein said determining of said scaling factor comprises:
calculating a scaling factor for a UI containing a plurality of elements, wherein said elements contain a plurality of tiles, utilizing a most constrained tile of said plurality of tiles as a limiting factor in said calculating of said scaling factor.

6. The computer-implemented method of claim 5 wherein said scaling factor comprises:
utilizing a density of pixels on said display interface in conjunction with a display resolution for calculating said scaling factor.

7. The computer-implemented method of claim 1 further comprising:
determining a font size characteristic wherein an adjustment to said font size adjusts each of a plurality of tiles in each of said plurality of elements within said UI.

8. The computer-implemented method of claim 1 further comprising:
creating a reference layout for each of said elements of a UI, wherein said reference layout optimizes a location for each of said elements of said UI; and
utilizing said reference layout to determine a minimum size for each of said elements in said UI.

9. A user interface (UI) standardizer comprising:
a UI element receiver for receiving a plurality of UI elements; and
a UI layout optimizer coupled with said UI element receiver, said UI layout optimizer for creating a UI layout of said plurality of UI elements, said UI layout optimizer providing a scaling factor and a reflow protocol for said UI layout such that each of said plurality of said UI elements in said UI layout maintains a minimum standard physical size regardless of a display interface on which it is presented.

10. The code functionality extractor of claim 9 wherein said scaling factor provides placement of said plurality of UI elements in said UI layout based on at least one characteristic of said display interface.

11. The code functionality extractor of claim 9 wherein said reflow of said plurality of elements is performed when said scaling factor of said UI layout on said display interface with a minimum standard physical size does not fit on said display interface.

12. The code functionality extractor of claim 9 wherein said UI layout optimizer further provides at least one scrollbar said at least one scrollbar provided for said UI layout when said scaling factor and said reflow does not satisfactorily represent said UI layout on said display interface.

13. The code functionality extractor of claim 9 wherein said UI layout optimizer further comprises:
a reference layout creator for creating a reference layout for said UI elements that determines a minimum UI element size.

14. The code functionality extractor of claim 13 wherein said UI layout optimizer further comprises:
a UI limiting factor definer for defining a limiting factor of said UI element based on said minimum UI element size.

15. Instructions on a computer-usable medium wherein the instructions when executed cause a computer system to perform a method for providing a standard user interface (UI) across disparate display interfaces, said computer-implemented method comprising:
calculating a scaling factor for a UI containing a plurality of elements, said scaling factor based on a minimum standard physical size for said plurality of UI elements;
performing a reflow of said plurality of elements within said UI when said scaling factor does not satisfactorily represent said UI on a display interface; and
providing at least one scrollbar on said display when displaying said plurality of elements within said UI when said scaling factor and said reflow does not satisfactorily represent said UI on said display, wherein said satisfactory representation comprises maintaining a standard physical size of said plurality of elements within said UI regardless of said display interface.

16. The computer-usable medium of claim 15 further comprising:
creating a reference layout for said elements of a UI, wherein said reference layout optimizes a location of said elements of said UI.

17. The computer-usable medium of claim 16 further comprising:
utilizing said reference layout to determine a minimum standard physical size for said elements of said UI.

18. The computer-usable medium of claim 17 further comprising:
determining limiting factors of said UI based on said minimum standard physical size for said elements of said UI determined by said reference layout, wherein said limiting factors are utilized in said calculating of said scaling factor.

19. The computer-usable medium of claim 15 wherein said element further comprises:
providing a plurality of tiles within each of said plurality of said UI elements, wherein the tile with the most constrained dimension of said plurality of tiles within each of said plurality of said UI elements is utilized when calculating said scaling factor.

20. The computer-usable medium of claim 15 further comprising: providing a plurality of tiles within each of said plurality of said UI elements, wherein an increase font size command results in a proportional increase in each of said plurality of tiles within each of said plurality of said UI elements.
